(19) United States
(12) Patent Application Publication
(10) Pub. No.: US 2025/0051120 A1
(43) Pub. Date: Feb. 13, 2025

(54) FILM TEARING DEVICE AND FILM TEARING METHOD

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Wei Zhou, Beijing (CN); Peng Wang, Beijing (CN); Rongkun Fan, Beijing (CN); Jialin Wang, Beijing (CN); Haitao Liang, Beijing (CN); Yu Gan, Beijing (CN); Liangdong Lin, Beijing (CN); Guodong Zhou, Beijing (CN); Lipeng Ye, Beijing (CN); Yongsong Meng, Beijing (CN); Xu Zhang, Beijing (CN); Yuan Liu, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 18/697,420

(22) PCT Filed: Aug. 9, 2023
(86) PCT No.: PCT/CN2023/111907

§ 371 Date: Mar. 29, 2024

(30) Foreign Application Priority Data
Aug. 24, 2022 (CN) 202211020576.5

(51) Int. Cl. B65H 18/08

(52) U.S. Cl. CPC B65H 18/08; B65H 2405/50; B65H 2701/1752

(57) ABSTRACT

A film tearing device for tearing a film on a component to be torn is referred to, includes: an easy-to-tear sticker, including a clamping portion and an adhesive portion disposed adjacently in a first direction; a film tearing roller, including a first portion and a second portion disposed opposite to each other, where the film tearing roller is configured to have a first state and a second state, in the first state, the first portion is matched with the second portion to clamp the clamping portion, and in the second state, the film tearing roller clamping the clamping portion rotates and moves in a second direction parallel to a surface of the component to be torn; a first moving structure for controlling the first portion and/or the second portion to move such that the film tearing roller is in the first state and second state.

### CROSS-REFERENCE TO RELATED APPLICATION

The present application claims priority to the Chinese patent application No. 202211020576.5 filed in China on Aug. 24, 2022, a disclosure of which is incorporated herein by reference in its entirety.

### TECHNICAL FIELD

The present disclosure relates to the field of mechanical technology, in particular to a film tearing device and film tearing method.

### BACKGROUND

With the gradual popularization of flexible OLED products, large-size vehicle-borne products become a new mainstream direction. The conventional way of tearing off a protective film is through a film tearing module or a robot. When dealing with large-size products such as vehicle-borne products, the conventional way of tearing the film may easily cause panel peeling or the protective film to lap again at the end of the film tearing to produce adhesive stretching, which destroys the product form and affects the product quality.

### SUMMARY

To solve the above technical problem, the present disclosure provides a film tearing device and a film tearing method, which solve the problem of panel peeling caused by film tearing.

In order to achieve the foregoing objective, the present disclosure provides the following technical solutions:

A film tearing device for tearing a film on a component to be torn, including:
an easy-to-tear sticker, including a clamping portion and an adhesive portion disposed adjacently in a first direction;
a film tearing roller, including a first portion and a second portion disposed opposite to each other, where the film tearing roller is configured to have a first state and a second state, in the first state, the first portion is matched with the second portion to clamp the clamping portion, and in the second state, the film tearing roller clamping the clamping portion rotates and moves in a second direction parallel to a surface of the component to be torn;
a first moving structure for controlling movement of the first portion and/or the second portion, such that the film tearing roller is in the first state and the second state;
a pressing roller located on a travelling path of the film tearing roller, where the pressing roller is pressed against the surface of the component to be torn;
a second moving structure for controlling the pressing roller to move in the second direction when the film tearing roller is in the second state.

Optionally, the film tearing roller further has a third state, in the third state, the first portion is connected to the adhesive portion, under the control of the first moving structure, moved to and adhered to an edge of the component to be torn.

Optionally, the clamping portion is a strip-shaped structure extending in a third direction perpendicular to the first direction, and the adhesive portion includes at least two sub-adhesive portions disposed at one side of the clamping portion at intervals in the third direction.

Optionally, the component to be torn includes a first edge, and the length of the clamping portion in the third direction is greater than half of the length of the first edge.

Optionally, the at least two sub-adhesive portions include a first sub-adhesive portion and a second sub-adhesive portion, and the first sub-adhesive portion and the second sub-adhesive portion are respectively used for adhering to two corners of the first edge.

Optionally, the first portion and the second portion have the same structure, the first portion includes a rigid clamping portion and a first elastic buffer portion coating the exterior of the rigid clamping portion, and the rigid clamping portion including a clamping surface, where the clamping surface is disposed exposed from the first elastic buffer portion.

Optionally, a plurality of adsorption holes are uniformly disposed on the clamping face, and the plurality of adsorption holes are connected to a vacuum pumping structure.

Optionally, the clamping surface is a planar structure.

Optionally, the pressing roller includes a rigid supporting portion and a second elastic buffer portion coating exterior of the rigid supporting portion

Optionally, the first moving structure includes:
a rotating disc, including a first guide groove and a second guide groove disposed in cross, where central axes of the second guide groove pass through a center point of the rotating disc, the first portion is movably disposed in the first guide groove, and the second portion is movably disposed in the second guide groove;
a lifting and moving unit, including a first guide plate extending in a vertical direction, where a third guide groove extending in the vertical direction is disposed on the first guide plate, and the rotating disc is movably disposed in the third guide groove;
a horizontal moving unit, including a fourth guide groove extending in the second direction, and the first guide plate is movably disposed in the fourth guide groove.

Optionally, the second moving structure is integrated with the first moving structure, the second moving structure incudes a second guide plate connected to the first guide plate, a fifth guide groove extending in the second direction and a sixth guide groove extending in the vertical direction are disposed the second guide plate, the sixth guide groove is movably disposed in the fifth guide groove, and the pressing roller is movably disposed in the sixth guide groove.

The present disclosure further provides a film tearing method using the foregoing film tearing device for tearing film, where the film tearing method includes:
the adhesive portion of the easy-to-tear sticker being adhered to the edge of the component to be torn;
the first portion being matched with the second portion, to clamp the clamping portion of the easy-to-tear sticker;
the pressing roller being pressed against the surface of the component to be torn;
the film tearing roller rotating and moving in the second direction, and the pressing roller being moved in the second direction until a film to be removed from the surface of the component to be torn is removed.

Optionally, the film tearing roller further has a third state, in the third state, the first portion is connected to the adhesive portion, under the control of the first moving structure, moved to and adhered to an edge of the component to be torn; the adhering the adhesive portion of the easy-to-tear sticker to the edge of the component to be torn, specifically includes:
the first portion connecting to the adhesive portion, and moving to the edge of the component to be torn, to cause the adhesive portion to adhere to the edge of the component to be torn.

Optionally, in the step of the rotating and moving in the second direction, by the film tearing roller, and the moving in the second direction, by the pressing roller, until the film to be removed on the surface of the component to be torn is removed includes:
the pressing roller being located on the travelling path of the film tearing roller, and the pressing roller and the film tearing roller moving synchronously in the second direction.

Beneficial effects of the present disclosure are as follow, the film is torn by matching the pressing roller with the film tearing roller, during the rotation of the film tearing roller to tear the film, the pressing roller is pressed down so as to prevent the peeling of the film layer of the panel caused by the excessive tensile stress between the panel and the film layer to be torn.

### BRIEF DESCRIPTION OF THE DRAWINGS

FIG. 1 is a schematic diagram of a structure of a film tearing device according to an embodiment of the present disclosure;

FIG. 2 is another schematic diagram of a structure of a film tearing device according to an embodiment of the present disclosure;

FIG. 3 is a schematic diagram of a structure of a film tearing roller according to an embodiment of the present disclosure;

FIG. 4 is a schematic diagram of a state of a film tearing roller clamping an easy-to-tear sticker and a pressing roller pressing against component to be torn;

FIG. 5 is a schematic diagram of a state of a film tearing roller rising to lift up a film;

FIG. 6 is a schematic diagram of a structure of an easy-to-tear sticker according to an embodiment of the present disclosure.

### DETAILED DESCRIPTION

In order to make objective, technical solutions, and benefits of the embodiments of the present disclosure clearer, the technical solutions in the embodiments of the present disclosure will be described clearly and completely with reference to the accompanying drawings. Obviously, the embodiments described are only some, but not all, of the embodiments of the present disclosure. Based on the described embodiments of the present disclosure, all other embodiments obtained by those of ordinary skill in the art fall within the protection scope of the present disclosure.

In the description of the present disclosure, it is to be appreciated that orientations or positional relationships indicated by terms such as “up”, “down”, “left”, “right”, “inside” and “outside” are based on the orientations or positional relationships shown in the drawings to facilitate and simplify the description of the present disclosure, not to indicate or imply that the means or elements involved should have specific orientations, or be constructed and operated with specific orientations, and therefore should not be construed as limiting of the present disclosure. In addition, the terms “first”, “second”, and “third” are used for descriptive purposes only and should not be construed as indicating or implying relative importance.

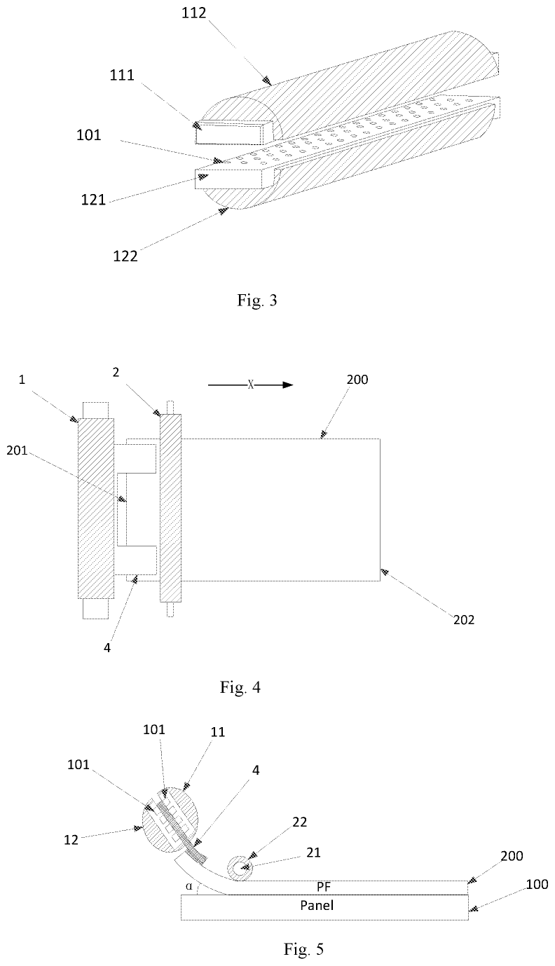

Referring to FIG. 1-FIG. 6, an embodiment of the present disclosure provides a film tearing device for tearing a film on a component to be torn, and the device includes:
an easy-to-tear sticker 4, including a clamping portion 41 and an adhesive portion 42 disposed adjacently in a first direction (with reference to the X-direction in FIG. 4);
a film tearing roller 1, including a first portion 11 and a second portion 12 disposed opposite to each other, where the film tearing roller 1 is configured to have a first state and a second state, in the first state, the first portion 11 is matched with the second portion 12 to clamp the clamping portion 41, and in the second state, the film tearing roller 1 clamping the clamping portion 41 rotates and moves in a second direction parallel to a surface of the component to be torn (the second direction is parallel to the first direction after the easy-to-tear sticker is adhered to the component to be torn);
a first moving structure for controlling movement of the first portion 11 and/or the second portion 12, such that the film tearing roller 1 is in the first state and the second state;
a pressing roller 2 located on a travelling path of the film tearing roller 1, where the pressing roller 2 is pressed against the surface of the component to be torn;
a second moving structure for controlling the pressing roller 2 to move in the second direction when the film tearing roller 1 is in the second state.

In this embodiment, the film is torn by matching the pressing roller 2 with the film tearing roller 1. The pressing roller 2 is provided on the travelling path of the film tearing roller 1, and the pressing roller 2 is pressed down so as to prevent the peeling of the film layer of the panel caused by the excessive tensile stress between the panel and the film layer to be torn.

In this embodiment, the film tearing roller 1 is moved in the second direction while rotating to remove the film to be removed, i.e., the film is removed by rolling the film, so that the risk of dust falling off is reduced and the problem of adhesive stretching caused by lapping the ends of the torn film again is prevented.

It should be noted that since the film tearing roller 1 includes a first portion 11 and a second portion 12 disposed opposite to each other, i.e., not a complete cylindrical structure. There is a gap at the junction of the first portion 11 and the second portion 12, in order to prevent the film tearing roller 1 from directly contacting with the component to be torn and affecting the flatness of the film layer on the surface of the component to be torn (e.g. a panel). In this embodiment, in the second state, the film tearing roller 1 is located above the component to be torn, i.e., the film tearing roller 1 and the component to be torn are not in contact. On this basis, the film tearing roller 1 is matched with the pressing roller 2 to tear the film so as to improve the quality of film tearing.

In an exemplary embodiment, the film tearing roller 1 further has a third state, in the third state, the first portion 11 is connected to the adhesive portion 42, under the control of the first moving structure, is moved to and adhered to an edge of the component to be torn.

The film tearing roller 1 includes a first portion 11 and a second portion 12 opposite to each other. The first portion 11 may be matched with the second portion 12 to clamp the easy-to-tear sticker 4 by clamping the clamping portion 41. A separate the first portion 11 may be connected to the adhesive portion 42 to control the movement of the easy-to-tear sticker 4 so as to enable the adhesive portion 42 to adhere to the edge of the component to be torn. That is to say, by the arrangement of the film tearing roller 1, the adhering of the easy-to-tear sticker 4 to the component to be torn and the film tearing can be achieved. No manual adhering is required, and no other movement control structure is required for adhering of the easy-to-tear sticker 4 to the component to be torn, thereby saving costs and simplifying operation steps.

It should be noted that the attachment of the film tearing roller 1 to the adhesive portion 42 may be varied, e.g. adsorption, Specific details will be described in subsequent embodiments.

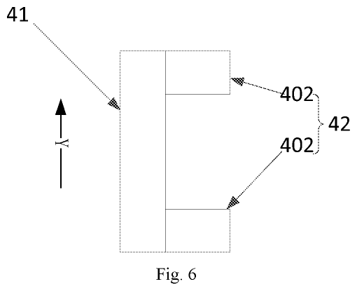

Referring to FIG. 4 and FIG. 6, in an exemplary embodiment, the clamping portion 41 is a strip-shaped structure extending in a third direction perpendicular to the first direction, and the adhesive portion 42 includes at least two sub-adhesive portions 402 disposed at one side of the clamping portion 41 at intervals in the third direction (referring to the Y-direction in FIG. 6).

In the foregoing manner, the area of the adhesive portion 42, that is, the adhering area between the easy-to-tear sticker 4 and the component to be torn is increased, thereby improving the film lifting rate.

The distance between two adjacent sub-adhesive portion 402 may be set according to actual needs, and the number of the sub-adhesive portion 402 included in the adhesive portion 42 may be set according to actual needs.

In an exemplary embodiment, the component to be torn includes a first edge 201, and the length of the clamping portion 41 in the third direction is greater than half of the length of the first edge 201.

The adhesive portion 42 is adhered to the first edge 201. The length of the clamping portion 41 in the third direction is greater than half of the length of the first edge 201. The second direction is perpendicular to the extension direction of the first edge 201, i.e., when tearing the film, starting from the first edge 201, the film tearing roller 1 moves along the second direction and towards a second edge 202 on the component to be torn opposite to the first edge 201 to tear the film. Compared with the related art, the easy-to-tear sticker 4 only adheres to one corner of the component to be torn and performs the film tearing along a diagonal line, thereby improving the film lifting success rate.

In an exemplary embodiment, the at least two sub-adhesive portions 402 include a first sub-adhesive portion and a second sub-adhesive portion, and the first sub-adhesive portion and the second sub-adhesive portion are respectively used for adhering to two corners of the first edge 201.

When tearing the film, the first sub-adhesive portion and the second sub-adhesive portion are respectively adhered to two adjacent corners of the first edge 201, increasing the adhering area and improving the film lifting success rate.

Exemplarily, the adhesive portion 42 may include a third sub-adhesive portion located between the first sub-adhesive portion and the second sub-adhesive portion. The third sub-adhesive portion is used for adhering the middle area along the extending direction of the first edge 201, further increasing the adhering area and improving the film lifting success rate.

The adhesive portion 42 is divided into a plurality of sub-adhesive portions 402 disposed at intervals, which are multi-point adhering, increasing the adhering area with the component to be torn and the force point of the component to be torn and improving the film lifting success rate.

In an exemplary embodiment, the adhesive portion 42 is an integral structure. The adhesive portion 42 is a strip-shaped structure extending in the same direction as the clamping portion 41. In the third direction, the length of the adhesive portion 42 is greater than half of the length of the first edge 201, increasing the adhering area with the component to be torn and improving the film lifting success rate.

In an exemplary embodiment, the first portion 11 and the second portion 12 have the same structure, the first portion includes a rigid clamping portion 111 and a first elastic buffer portion 112 coating the exterior of the rigid clamping portion 111, and the rigid clamping portion 111 includes a clamping surface, where the clamping surface is disposed exposed from the first elastic buffer portion 112.

The arrangement of the first elastic buffer portion 112 makes it possible to increase the friction between the film tearing roller 1 and the film (the film to be removed on the component to be torn), for a better rolling of the film.

In an exemplary embodiment, a plurality of adsorption holes 101 are uniformly disposed on the clamping surface, and the plurality of adsorption holes 101 are connected to a vacuum pumping structure.

The film is fixed by means of adsorption, so as to facilitate picking and placing. Especially after the first portion 11 adsorbs the side of the adhesive portion 42 which is not provided with an adhesive layer, the easy-to-tear sticker 4 is adhered to the edge of the component to be torn, the first portion 11 needs to be separated from the adhesive portion 42, and then be matched with the second portion 12 to clamp the clamping portion 41.

Exemplarily, the number of the adsorption holes 101 on the clamping surface can be set according to actual needs, and the distribution density and the size of the adsorption holes 101 can both be set according to actual needs. In one embodiment, three rows of the adsorption holes 101 are disposed in the radial direction of the film tearing roller 1, and each row of the adsorption holes 101 includes a plurality of the adsorption holes 101 disposed at intervals, but is not limited in this way.

Exemplarily, an orthographic projection of a first adsorption hole in one row of the adsorption holes 101 onto another row of the adsorption holes 101 may overlap with a second adsorption hole in the another row of the adsorption holes 101 or may be located between two adjacent adsorption holes 101 in the another row of the adsorption holes 101.

Exemplarily, the orthographic projection of the adsorption holes 101 on the first portion 11 on the second portion 12 overlaps with the adsorption holes 101 on the second portion 12.

Exemplarily, the orthographic projection of the adsorption holes 101 on the first portion 11 on the second portion 12 is staggered from the adsorption holes 101 on the second portion 12, i.e., the orthographic projection of the adsorption holes 101 on the first portion 11 on the second portion 12 is located between two adjacent adsorption holes 101 on the second portion 12.

In an exemplary embodiment, the clamping surface is a planar structure. The arrangement of a planar structure ensures the flatness of the easy-to-tear sticker 4, facilitating the adhering of the adhesive portion 42 to the component to be torn product.

In an exemplary embodiment, the pressing roller 2 includes a rigid supporting portion 121 and a second elastic buffer portion 122 coating the exterior of the rigid supporting portion 121.

The rigid supporting portion 121 is disposed to ensure the strength of the pressing roller 2 and uniform stress on the component to be torn. The second elastic buffer portion 122 is disposed to avoid damage to the component to be torn by the pressing roller 2.

The specific structural form of the first moving structure may vary. In an exemplary embodiment, the first moving structure includes:
a rotating disc 31, including a first guide groove 301 and a second guide groove 302 disposed in cross, where central axes of the second guide groove 302 pass through a center point of the rotating disc 31, the first portion 11 is movably disposed in the first guide groove 301, and the second portion 12 is movably disposed in the second guide groove 302;
a lifting and moving unit, including a first guide plate 32 extending in a vertical direction, where a third guide groove 303 extending in the vertical direction is disposed on the first guide plate 32, and the rotating disc 31 is movably disposed in the third guide groove 303;
a horizontal moving unit, including a fourth guide groove 304 extending in the second direction, and the first guide plate 32 is movably disposed in the fourth guide groove 304.

Exemplarily, the first guide groove 301 and the second guide groove 302 are disposed vertically. In the third state, the first guide groove 301 is disposed horizontally (parallel to the surface of the component to be torn). The first portion 11 may be moved along the first guide groove 301 driven by a cylinder, to adhere the adhesive portion 42 to the edge of the component to be torn. After the adhesive portion 42 is adhered to the edge of the component to be torn, the first portion 11 reverses movement to the center point of the rotating disc 31 to match with the second portion 12 to clamp the clamping portion 41.

Before controlling the first portion 11 to move along the first guide groove 301, lifting of the first portion 11 may be controlled by the lifting and moving unit (the lifting and moving unit may include a cylinder by which the rotating disc 31 may be driven to move along the third guide groove 303), so that the first portion 11 adsorbs the adhesive portion 42.

In some embodiments, the guide plate may be driven by a cylinder to move along the fourth guide groove 304, so that the first portion 11 moves the easy-to-tear sticker 4 to adhere the adhesive portion 42 to the component to be torn edge.

The second portion 12 may be driven by a cylinder to move along the second guide groove 302 so that the first portion 11 is matched with the second portion 12.

It should be noted that the first guide groove 301 and the second guide groove 302 may be interconnected to facilitate the movement of the first portion 11 and/or the second portion 12. The first guide groove 301 and the second guide groove 302 may also be disconnected to facilitate the alignment of the first portion 11 and the second portion 12. For example, one end of the first guide groove 301 is a blocking end, along the extension direction of the first guide groove 301, the blocking surface of the blocking end coincides with the side wall of the side of the second guide groove 302 away from the first guide groove 301. That is to say, when the first portion 11 is located at the blocking end, the first portion 11 is directly opposite to the second portion 12 (the orthographic projection of the first portion 11 in the extension direction of the second guide groove 302 overlaps with the second portion 12).

It should be noted that the connection between the first portion 11 and the first guide groove 301 may be through a slider having a shape conforming to the shape of the first guide groove 301, but is not limited thereto.

Exemplarily, the rigid clamping portion 111 further includes a first exposing portion exposed to the first elastic buffer portion 112 in the extending direction of the film tearing roller 1. The first exposing portion is multiplexed as the slider.

Exemplarily, the connection between the second portion 12 and the second guide groove 302 may be through a slider, but is not limited thereto.

Exemplarily, the rigid supporting portion 121 further includes a second exposing portion exposed to the second elastic buffer portion 122 in the extending direction of the film tearing roller 1. The second exposing portion is multiplexed as the slider.

After the first portion 11 is matched with the second portion 12 to clamp the clamping portion 41, the rotating disc 31 may be driven by an cylinder to move along the third guide groove 303, so that the rotating disc 31 moves in a direction away from the component to be torn, thereby achieving film lifting (the film lifting angle may be set according to actual needs, and for example, can be 45 degrees, but is not limited thereto).

Exemplarily, the rotating disc 31 is connected to a drive motor via a rotating shaft. The first guide plate 32 has a first side and a second side opposite to each other along the thickness direction thereof. The rotating disc 31 is located on the first side. The bottom of the second guide groove 302 is disposed with a strip-shaped through hole disposed through the guide plate. The extension direction of the strip-shaped through hole is parallel to the extension direction of the second guide groove 302. A moving slide block is disposed between the rotating disc 31 and the second guide groove 302, and a through hole is disposed on the moving slide block. The rotating shaft is drivingly connected to the driving motor at the second side through the through hole and the strip-shaped through hole.

Exemplarily, a cross-sectional shape of the first guide groove 301 is trapezoidal in a direction perpendicular to an extending direction of the first guide groove 301. An area of an open end of the first guide groove 301 is lessr than an area of a bottom of the first guide groove 301.

Exemplarily, a cross-sectional shape of the second guide groove 302 is trapezoidal in a direction perpendicular to an extending direction of the second guide groove 302. An area of an open end of the second guide groove 302 is less than an area of a bottom of the second guide groove 302.

Exemplarily, a cross-sectional shape of the third guide groove 303 is trapezoidal in a direction perpendicular to an extending direction of the third guide groove 303. An area of an open end of the third guide groove 303 is less than an area of a bottom of the third guide groove 303.

Exemplarily, a cross-sectional shape of the fourth guide groove 304 is trapezoidal in a direction perpendicular to an extending direction of the fourth guide groove 304. An area of an open end of the fourth guide groove 304 is less than an area of a bottom of the fourth guide groove 304.

The movement of the film tearing roller 1 and the movement of the pressing roller 2 may be independently driven, may be uniformly controlled, may be synchronized movement, or may be unsynchronized movement. In an exemplary embodiment, the second moving structure is integrated with the first moving structure. The second moving structure includes a second guide plate 33 connected to the first guide plate 32. The second guide plate 33 is disposed with a fifth guide groove 305 extending in the second direction and a sixth guide groove 306 extending in the vertical direction. The sixth guide groove 306 is movably disposed in the fifth guide groove 305 (the sixth guide groove 306 may move along the fifth guide groove in the second direction), and the pressing roller 2 is movably disposed in the sixth guide groove 306.

The first guide plate 32 moves along the fourth guide groove 304 so as to drive the film tearing roller 1 to move in a direction parallel to the surface of the component to be torn to roll a film, and at the same time, the second guide plate 33 is driven to move synchronously. And then the pressing roller 2 is driven to move synchronously, so as to maintain the distance between the film tearing roller 1 and the pressing roller 2 in a direction parallel to the surface of the component to be torn. This avoids the problem that the film layer on the surface of the component to be torn is subjected to a large pulling force of the film to be removed due to the excessive distance between the film tearing roller 1 and the pressing roller 2 in the direction parallel to the surface of the component to be torn so as to cause peeling. This also avoids the problem that the film to be removed is stressed too much and breaks due to too small a distance between the film tearing roller 1 and the pressing roller 2 in a direction parallel to the surface of the component to be torn.

The arrangement of the fifth guide groove 305 may adjust the distance between the pressing roller 2 and the film tearing roller 1 in the second direction. The arrangement of the sixth guide groove 306 may adjust the height of the pressing roller 2 in the vertical direction so as to adjust the pressure applied to the surface of the component to be torn. This avoid damage to the surface of the component to be torn caused by excessive pressure, or avoid the problem that the pressure is too low to act as a function of pressing down the film to be removed, so as to prevent the film layer on the surface of the component to be torn from peeling due to a large pulling force.

An embodiment of the present disclosure further provides a film using the foregoing film tearing device for tearing film, and the method includes the following steps. The adhesive portion 42 of the easy-to-tear sticker 4 is adhered to the edge of the component to be torn; the first portion 11 is matched with the second portion 12, to clamp the clamping portion 41 of the easy-to-tear sticker 4; the pressing roller 2 is pressed against the surface of the component to be torn; the film tearing roller 1 rotates and moves in the second direction, and the pressing roller 2 moves in the second direction until the film to be removed on the surface of the component to be torn is removed.

In an exemplary embodiment, the film tearing roller 1 further has a third state, in the third state, the first portion 11 is connected to the adhesive portion 42, under the control of the first moving structure, moved to and adhered to an edge of the component to be torn.

The adhering the adhesive portion 42 of the easy-to-tear sticker 4 to the edge of the component to be torn, specifically includes: the adhesive portion 42 being connected to the first portion 11, and the first portion 11 moves to the edge of the component to be torn, to cause the adhesive portion 42 to adhere to the edge of the component to be torn.

In an exemplary embodiment, in the step of the film tearing roller 1 rotating and moving in the second direction and the pressing roller 2 moving in the second direction until the film to be removed on the surface of the component to be torn is removed includes: the pressing roller 2 is located on the travelling path of the film tearing roller 1, and the pressing roller 2 and the film tearing roller 1 move synchronously in the second direction.

Exemplarily, after the step of the first portion 11 being matching with the second portion 12, to clamp the clamping portion 41 of the easy-to-tear sticker 4, the method further includes: the film tearing roller 1 rising to achieve film lifting.

Taking the component to be torn as a rectangular display panel 100 and the film to be removed from the component to be torn as a protective film 200 as an example, the process of film tearing using the foregoing film tearing device in this embodiment will be described in detail.

The first portion 11 of the film tearing roller 1 adsorbs the adhesive portion 42 of the easy-to-tear sticker 4, and under the control of the first moving structure, the adhesive portion 42 is driven to be connected to a first edge 201 (corresponding to one side of a long side or a short side of the rectangular display panel 100) of the display panel 100.

The first portion 11 releases the adsorption. Under the control of the first moving structure, the first portion 11 is matched with the second portion 12 to clamp the clamping portion 41 of the easy-to-tear sticker 4.

Under the control of the second moving structure, the pressing roller 2 is pressed against the surface of the protective film 200, and the pressing roller 2 is located on the travelling path of the film tearing roller 1 (in the moving direction of the film tearing roller 1, the distance between the pressing roller 2 and the film tearing roller 1 may be set according to actual needs).

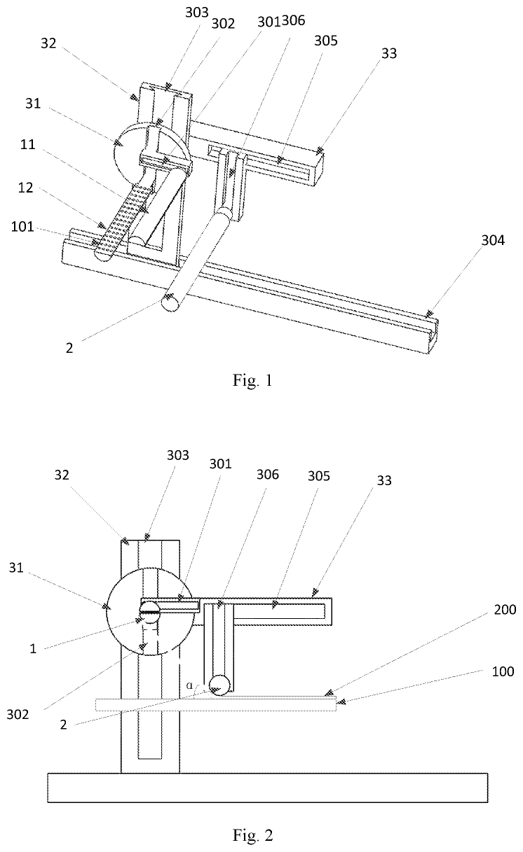

Under the control of the first moving structure, the film tearing roller 1 rises (moving in a direction away from the display panel 100) to lift the film (rolling up the lift-off end of the protective film 200, and the distance that the film tearing roller 1 rises may be set according to actual needs. For example, after the film tearing roller 1 rises a preset distance, part of the protective film 200 is peeled off from the display panel 100, and an inclined plane is formed between the display panel 100 and the film tearing roller 1, where the angle α between the inclined plane and the display panel 100 is 45 degrees, with reference to FIG. 2 and FIG. 5).

Under the control of the first moving structure, the film tearing roller 1 rotates and moves in the second direction (the rectangular display panel 100 includes the first edge 201 and a second edge 202 opposite to the first edge 201, and the second direction is a direction from the first edge 201 to the second edge 202), and under the control of the second moving structure, the pressing roller 2 moves in the second direction in synchronization with the film tearing roller 1 until the protective film 200 on the display panel 100 is removed.

It should be noted that, in order to prevent dust and the like on the protective film 200 from falling onto the surface of the display panel 100, the film tearing roller 1 stops moving until the protective film 200 is completely peeled off, and even stops moving in the second direction until the protective film 200 is completely wound around the film tearing roller 1. When the film tearing roller 1 stops moving (i.e., at the end of moving), the orthographic projection of the film tearing roller 1 on the display panel 100 is located on the side of the second edge 202 away from the first edge 201.

It is to be understood that the above embodiments are merely exemplary embodiments adopted to illustrate the principles of the present disclosure, but the present disclosure is not limited thereto. For those skilled in the art, various variations and improvements may be made without departing from the spirit and essence of the present disclosure, and these variations and improvements also fall within the protection scope of the present disclosure.

1. A film tearing device for tearing a film on a component to be torn, comprising:
an easy-to-tear sticker, comprising a clamping portion and an adhesive portion disposed adjacently in a first direction;
a film tearing roller, comprising a first portion and a second portion disposed opposite to each other, wherein the film tearing roller is configured to have a first state and a second state, the first portion is matched with the second to clamp the clamping portion in the first state, and in the second state, the film tearing roller clamping the clamping portion rotates and moves in a second direction, and the second direction is parallel to a surface of the component to be torn;
a first moving structure, for controlling movement of the first portion and/or the second portion, to cause the film tearing roller to be in the first state and the second state;
a pressing roller, located on a travelling path of the film tearing roller, wherein the pressing roller is pressed against the surface of the component to be torn;
a second moving structure, for controlling the pressing roller to move in the second direction when the film tearing roller is in the second state.

2. The film tearing device according to claim 1, wherein the film tearing roller further has a third state, in the third state, the first portion is connected to the adhesive portion, under the control of the first moving structure, moved to and adhered to an edge of the component to be torn.

3. The film tearing device according to claim 1, wherein the clamping portion is a strip-shaped structure extending in a third direction perpendicular to the first direction, and the adhesive portion comprises at least two sub-adhesive portions disposed at one side of the clamping portion at intervals in the third direction.

4. The film tearing device according to claim 3, wherein the component to be torn comprises a first edge, and a length of the clamping portion in the third direction is greater than half of a length of the first edge.

5. The film tearing device according to claim 4, wherein the at least two sub-adhesive portions comprise a first sub-adhesive portion and a second sub-adhesive portion, and the first sub-adhesive portion and the second sub-adhesive portion are respectively used for adhering to two corners of the first edge.

6. The film tearing device according to claim 1, wherein
the first portion and the second portion have a same structure, the first portion comprises a rigid clamping portion and a first elastic buffer portion coating exterior of the rigid clamping portion,
the rigid clamping portion comprises a clamping surface, and the clamping surface is disposed exposed from the first elastic buffer portion.

7. The film tearing device according to claim 6, wherein a plurality of adsorption holes are uniformly disposed on the clamping face, and the plurality of adsorption holes are connected to a vacuum pumping structure.

8. The film tearing device according to claim 6, wherein the clamping surface is a planar structure.

9. The film tearing device according to claim 6, wherein the pressing roller comprises a rigid supporting portion and a second elastic buffer portion coating the exterior of the rigid supporting portion.

10. The film tearing device according to claim 6, wherein the first moving structure comprises:
a rotating disc, comprising a first guide groove and a second guide groove disposed in cross, wherein central axes of the second guide groove pass through a center point of the rotating disc, the first portion is movably disposed in the first guide groove, and the second portion is movably disposed in the second guide groove;
a lifting and moving unit, comprising a first guide plate extending in a vertical direction, wherein a third guide groove extending in the vertical direction is disposed on the first guide plate, and the rotating disc is movably disposed in the third guide groove;
a horizontal moving unit, comprising a fourth guide groove extending in the second direction, wherein the first guide plate is movably disposed in the fourth guide groove.

11. The film tearing device according to claim 10, wherein the second moving structure is integrated with the first moving structure, the second moving structure comprises a second guide plate connected to the first guide plate, a fifth guide groove extending in the second direction and a sixth guide groove extending in the vertical direction are disposed the second guide plate, the sixth guide groove is movably disposed in the fifth guide groove, and the pressing roller is movably disposed in the sixth guide groove.

12. A film tearing method, wherein the film tearing method, by using the film tearing device according to claim 1 for tearing film, comprises:
the adhesive portion of the easy-to-tear sticker being adhered to an edge of the component to be torn;
the first portion being matched with the second portion, to clamp the clamping portion of the easy-to-tear sticker;
the pressing roller being pressed against the surface of the component to be torn;
the film tearing roller rotating and moving in the second direction, and the pressing roller being moved in the second direction until a film to be removed from the surface of the component to be torn is removed.

13. The film tearing method according to claim 12, wherein the film tearing roller further has a third state, in the third state, the first portion is connected to the adhesive portion, under the control of the first moving structure, moved to and adhered to the edge of the component to be torn;
the adhering the adhesive portion of the easy-to-tear sticker to the edge of the component to be torn, specifically comprises:
the first portion connecting to the adhesive portion, and moving to the edge of the component to be torn, to cause the adhesive portion to adhere to the edge of the component to be torn.

14. The film tearing method according to claim 12, wherein in the step of the film tearing roller rotating and moving in the second direction, and the pressing roller being moved in the second direction until a film to be removed from the surface of the component to be torn is removed comprises:
the pressing roller being located on the travelling path of the film tearing roller, and the pressing roller and the film tearing roller moving synchronously in the second direction.
